(19) United States
(12) Patent Application Publication
(10) Pub. No.: US 2009/0018885 A1
(43) Pub. Date: Jan. 15, 2009

(54) RISK MANAGEMENT AND COMPLIANCE SYSTEM AND RELATED METHODS

(76) Inventor: Joseph D. Parales, Tempe, AZ (US)

Correspondence Address: BOOTH UDALL, PLC, 1155 W. Rio Salado Pkwy., Suite 101, Tempe, AZ, 85281, US

(21) Appl. No.: 12/242,753

(22) Filed: Sep. 30, 2008

Related U.S. Application Data
(60) Provisional application No. 60/989,765, filed on Nov. 21, 2007.

(51) Int. Cl. G06F 9/44; G06Q 40/00; G06Q 10/00; G06Q 90/00

(52) U.S. Cl. 705/7; 705/35; 705/1

(57) ABSTRACT

Implementations of a method of managing risk and compliance method may include providing one or more controls, monitoring a business activity to produce one or more monitoring results, evaluating the one or more controls using risk criteria from a risk database to produce one or more control gaps, evaluating a business process using the one or more risk criteria to produce one or more control gaps, remediating one or more of the one or more controls, receiving an audit request, communicating information regarding the one or more controls in response to the audit request, receiving an audit report including one or more audit findings, evaluating the one or more audit findings to identify one or more control gaps, and remediating one or more of the one or more controls using the one or more control gaps.

### CROSS REFERENCE TO RELATED APPLICATIONS

This document claims the benefit of the filing date of U.S. Provisional Patent Application 60/989,765 entitled “Internal Control and Risk Assessment Systems and Related Methods” to Joseph D. Parales which was filed on Nov. 21, 2007, the disclosure of which is hereby incorporated entirely herein by reference.

### BACKGROUND

1. Technical Field

Aspects of this document relate generally to compliance, risk management, and auditing systems and methods.

2. Background Art

Many companies undergo periodic audits. These audits may be conducted both internally and externally and may examine a wide variety of company systems and processes. For example, various standards organizations send representatives to conduct audits of facilities to ensure that the facilities are operating in accordance with the requirements outlined in a particular standard (the ISO 9001 standard, for example, promulgated by the International Organization for Standardization). Assessing compliance during an audit is conventionally performed by the auditor gathering and receiving data from a company about its systems and operations. The auditor then analyzes the data and then makes a determination whether the company and/or its systems are compliant. The intent behind many audit processes is to uncover issues that, if left uncorrected, represent risks to the business.

### SUMMARY

Implementations of risk management and control systems may include a compliance database configured to receive one or more compliance and risk drivers and a control objective database coupled with the compliance database and configured to receive one or more control objectives based at least in part on the one or more compliance and risk drivers. The system may include one or more controls configured to correspond with the one or more control objectives stored in the control objective database and configured to monitor a business activity to produce one or more monitoring results. One or more tests may be coupled with the one or more controls and may be configured to validate the performance of the one or more controls. A control risk evaluation module may be coupled with the one or more controls and may be coupled with a risk database. The control risk evaluation module may be configured to evaluate the one or more controls using one or more risk criteria stored in the risk database and to produce one or more control gaps. A process risk evaluation module may be coupled with the risk database and may be configured to evaluate a process including one or more controls using the one or more risk criteria stored in the risk database to produce one or more control gaps. A control remediation module may be coupled with the one or more controls and to an audit report findings evaluation module. The control remediation module may be configured to remediate one or more controls using the one or more control gaps. An audit response module may be coupled with the one or more controls and may be configured to receive one or more audit requests and to communicate information relating to the one or more controls in response to the one or more audit request. An audit findings evaluation module may be coupled with the one or more controls and may be configured to receive one or more audit reports including one or more audit findings, to evaluate the one or more audit findings, and to generate one or more control gaps corresponding with one or more of the audit findings.

Implementations of risk management and compliance systems may include one, all, or some of the following:

The system may include a plurality of nodes and the control risk evaluation module and the process risk evaluation module may be configured to evaluate the one or more controls and to evaluate the process including one or more controls at one or more of the plurality of nodes included in the risk management and compliance system.

The control risk evaluation module and the process risk evaluation module may be configured to evaluate risk at a node by iterating to determine an amount of mitigation at the node to obtain an acceptable level of risk, calculating a risk exposure at the node, calculating a probability of a risk event at the node, determining a type of impact from the risk event at the node, and determining a financial impact of the risk event at the node.

Implementations of risk management and compliance systems may utilize implementations of a method of implementing a risk management and compliance system. Implementations of the method may include compiling one or more compliance and risk drivers and storing the one or more compliance and risk drivers in a compliance database and generating one or more control objectives using the one or more compliance and risk drivers in the compliance database and storing the one or more control objectives in a control objectives database. The method may also include determining one or more control requirements using one or more of the control objectives stored in the control objectives database and storing the one or more control requirements in a control requirements database and selecting one or more control requirements from the control requirements database and assigning development of the one or more controls corresponding with the one or more control requirements to one or more control areas. The method may include developing the one or more controls, testing the one or more controls by developing one or more tests for the one or more controls being developed, performing the one or more tests with the one or more controls, and evaluating the results of the one or more tests. The method may also include evaluating one the one or more controls using risk criteria included in a risk database to determine one or more control gaps corresponding with the risk criteria and evaluating a business process including one or more controls using risk criteria included in the risk database to determine one or more control gaps corresponding with the one or more controls included in the business process or with the business process. The method may also include remediating one or more of the one or more controls using the one or more control gaps and transmitting information relating to the one or more controls in response to an audit request. The method may include receiving an audit report regarding the one or more controls including one or more audit findings and remediating the one or more controls in response to the one or more audit findings by evaluating the one or more audit findings, determining one or more control gaps corresponding with one or more of the audit findings, and using the one or more control gaps to remediate the one or more controls.

Implementations of a method of implementing a risk management and compliance system may include one, all, or any of the following:

Developing the one or more controls may further include designing, certifying, and validating the one or more controls.

Developing the one or more tests for the one or more controls may further include designing the one or more tests, selecting a test cycle, certifying the one or more tests, and validating the one or more tests.

Remediating the one or more controls may further include redesigning, retesting, or recertifying the one or more controls or adding one or more controls.

Transmitting information relating to the one or more controls in response to the audit request may further include transmitting an audit trail produced by the one or more controls.

The one or more compliance and risk drivers may include one of the Sarbanes-Oxley process, the Federal Depository Insurance Corporation process, the Six Sigma Reengineering process, internal compliance processes, internal policies, management directives, customer requirements, department objectives, and any combination thereof.

Evaluating risk criteria associated with the one or more controls and evaluating a business process including one or more controls may further include evaluating risk at one or more of a plurality of nodes included in a risk management and compliance system using risk criteria included in a risk database.

Evaluating risk at one or more of the plurality of nodes included in the risk management and compliance system may further include performing one of Process Risk Assessment (PRA), Compliance Risk Assessment (CRA), Objective Risk Assessment (ORA), Risk Monitoring Risk Assessment (RMRA), and any combination thereof.

Evaluating risk at one or more of the plurality of nodes included in a risk management and compliance system may further include identifying objectives for assessing and managing information relating to the risk management and compliance system at a control objective mapping node, an audit request analysis node, a providing audit evidence analysis node, and a control remediation control objective mapping node.

Evaluating risk at one or more of the plurality of nodes included in the risk management and compliance system may further include using a method of managing risk at a node including iterating to determine an amount of mitigation at the node that results in an acceptable level of residual risk, calculating a risk exposure at the node, calculating a probability of a risk event at the node, determining one or more impact types from the risk event at the node, and determining one or more impacts from the one or more impact types corresponding with the risk event at the node.

Implementations of risk management and compliance system may utilize implementations of a method of managing risk and compliance. Implementations of the method may include providing one or more controls developed using one or more control requirements from a control requirements database where the one or more control requirements may be based on one or more control compliance and risk drivers from a compliance database and the one or more controls may be validated using one or more tests. The method may include monitoring a business activity with the one or more controls to produce one or more monitoring results, evaluating the one or more controls using one or more risk criteria from a risk database to produce one or more control gaps, and evaluating a business process including one or more controls using one or more risk criteria from the risk database to produce one or more control gaps. The method may also include remediating one or more of the one or more controls in response to the one or more control gaps, receiving an audit request, communicating information regarding the one or more controls in response to receiving the audit request, receiving an audit report including one or more audit findings, evaluating the one or more audit findings to identify one or more control gaps corresponding with one or more of the audit findings, and remediating one or more of the one or more controls using the one or more control gaps corresponding with the one or more audit findings.

Implementations of a method of managing risk and compliance may include one, all, or any of the following:

Remediating one or more of the one or more controls may further include redesigning, retesting, and recertifying the one or more controls or adding one or more controls.

Communicating information relating to the one or more controls in response to the audit request may further include transmitting an audit trail produced by the one or more controls.

Evaluating the one or more controls and evaluating a business process including one or more controls may further include evaluating risk at one or more of a plurality of nodes included in a risk management and compliance system using risk criteria included in a risk database.

Evaluating risk at one or more of the plurality of nodes included in the risk management and compliance system may include performing one of Process Risk Assessment (PRA), Compliance Risk Assessment (CRA), Objective Risk Assessment (ORA), Risk Monitoring Risk Assessment (RMRA), and any combination thereof.

Evaluating risk at one or more of the plurality of nodes included in the risk management and compliance system may further include identifying objectives for assessing and managing information relating to the risk management and compliance system at a control objective mapping node, an audit request analysis node, a providing audit evidence analysis node, and a control remediation control objective mapping node.

Evaluating risk at one or more of the plurality of nodes included in the risk management and compliance system may further include using a method of managing risk at a node including iterating to determine an amount of mitigating at the node that results in an acceptable level of residual risk, calculating a risk exposure at the node, calculating a probability of a risk event at the node, determining one or more impact types from the risk event at the node, and determining one or more impacts from the one or more impact types corresponding with the risk event at the node.

The foregoing and other aspects, features, and advantages will be apparent to those artisans of ordinary skill in the art from the DESCRIPTION and DRAWINGS, and from the CLAIMS.

### BRIEF DESCRIPTION OF THE DRAWINGS

Implementations will hereinafter be described in conjunction with the appended drawings, where like designations denote like elements, and:

FIG. 1 is a diagram illustrating the various classifications and subclassifications the describe various uses and aspects of implementations of controls;

FIG. 2 is a diagram illustrating the various areas within a business process in which an implementation of a control could operate;

FIG. 3A is a block diagram of an implementation of a process with a single control;

FIG. 3B is a block diagram of an implementation of a process with multiple process steps with multiple controls;

FIG. 4 is a block diagram of a first implementation of a risk management and compliance system;

FIG. 5 is a block diagram of a first section of a second implementation of a risk management and compliance system;

FIG. 6 is a block diagram of a second section of a second implementation of a risk management and compliance system;

FIG. 7 is a block diagram of a third section of a second implementation of a risk management and compliance system;

FIG. 8 is a block diagram of a fourth section of a second implementation of risk management and compliance system;

FIG. 9 is a block diagram of the first implementation of the risk management and compliance system illustrated in FIG. 4 illustrating a plurality of nodes used for risk assessment;

FIG. 10 is a block diagram of the first section of the second implementation of the risk management and compliance system illustrated in FIG. 5 illustrating a plurality of nodes used for risk assessment;

FIG. 11 is a block diagram of the second section of the second implementation of the risk management and compliance system illustrated in FIG. 6 illustrating a plurality of nodes used for risk assessment;

FIG. 12 is a block diagram of the third section of the second implementation of the risk management and compliance system illustrated in FIG. 7 illustrating a plurality of nodes used for risk assessment;

FIG. 13 is a block diagram of the fourth section of the second implementation of the risk management and compliance system illustrated in FIG. 8 illustrating a plurality of nodes used for risk assessment;

FIG. 14 is a flowchart of an implementation of a method of a method of managing risk at a node;

FIG. 15 is a flowchart of an implementation of a method of implementing a risk management and compliance system;

FIG. 16 is a flowchart of an implementation of a method of managing risk and compliance.

### DESCRIPTION

This disclosure, its aspects and implementations, are not limited to the specific components or assembly procedures disclosed herein. Many additional components and assembly procedures known in the art consistent with the intended risk management and compliance system and/or assembly procedures for a risk management and compliance system will become apparent for use with particular implementations from this disclosure. Accordingly, for example, although particular implementations are disclosed, such implementations and implementing components may comprise any shape, size, style, type, model, version, measurement, concentration, material, quantity, and/or the like as is known in the art for such risk management and compliance systems and implementing components, consistent with the intended operation.

Processes, particularly processes for industrial and business applications, are structured to provide certain controls at various process steps to ensure a wide variety of desired process outcomes and to prevent a wide variety of undesired process outcomes. For example, in a chemical process, a pressure gauge may be used to determine when a particular vessel is completely filled with a compressed gas. In a business process, a signature loop may be implemented to ensure both that the approval of a particular purchase order was properly documented and that the purchase order amount was properly authorized. A wide variety of control types exist and are described in various frameworks developed by standards and industry organizations to aid with the analysis and auditing of industrial and business processes. Some of the control frameworks include the COSO framework formed by the Committee of Sponsoring Organizations of the Treadway Commission, the COBIT (Control Objectives for Information and related Technology) framework created by the Information Systems Audit and Control Association and the IT Governance Institute, and the ITIL® (Information Technology Infrastructure Library) promulgated by the United Kingdom's Office of Government Commerce. Many other organizations and individuals have also developed other various control definitions and descriptions.

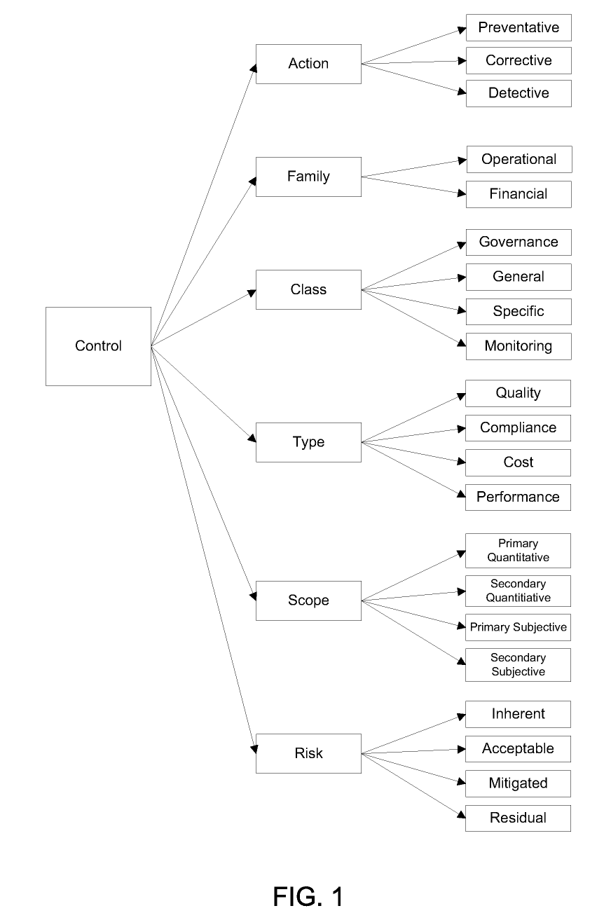

Referring to FIG. 1, a diagram illustrating the various classifications and subclassifications that describe various uses for and aspects of various implementations of controls is illustrated. As illustrated, what a control is can be described by the words action, family, class, type, scope, or risk. Action controls are those with preventative, corrective, or detective functions in a process. Family controls are those that are operational (those dealing with the operation of the process), and those that are financial (those concerned with the financial integrity of the process, such as the validity and accuracy of information on financial reports). Class controls are organized by the way in which the control is implemented in the workflow of the process. For example, governance controls are used to ensure compliance to a process requirement. General controls are used to control processes that are completed by one part of the process or organization on behalf of the rest of the process or other organizations. Specific controls operate within one process and/or for the benefit of a single organization. Monitoring controls are those that are used to watch processes or portions of processes that do not yet have controls or certified controls in place that permit direct control and/or monitoring. Finally, type controls are those that measure specific process outcomes or objectives, such as quality, compliance, cost, and performance.

The scope aspect of a control determines both the control's degree of independence from other controls and its strength. For example, a primary control does not rely on any other control to accomplish its objective. A quantitative control is stronger than a qualitative control because it utilizes actual objective process data. Accordingly, during the selection of any control, the ultimate strength of the control and its ability based on the way it interacts with the process and goes about monitoring the process are key considerations.

Because one of the purposes of controls is to manage risk in a process, the risk aspect of a control is a primary focus during control design. Without a control, a process has a certain inherent risk of a particular harmful outcome occurring (such as a misstatement on a financial report). A process owner can define an acceptable or desired level of risk before a control is implemented and iteratively design and test a control to mitigate the inherent risk. The amount of risk remaining after the mitigation process during control design is called residual risk. While the foregoing is a brief introduction to the different kinds of and aspects of controls, additional information regarding the classifications of, function, structure, implementation, and use of controls may be found in the U.S. Provisional Patent Application 60/989,765 entitled “Internal Control and Risk Assessment Systems and Related Methods” to Joseph D. Parales filed on Nov. 21, 2007 which was previously incorporated by reference.

When considering whether to implement a control, experience has shown that controls are best developed and implemented when the responsibility for design and certification is assigned to individuals working in the area in which the control will operate and where the assigned individuals work with an independent group tasked with implementing a uniform approach to control development throughout the company or process. Provided sufficient external input during development is in place to ensure compliance with standards, controls created by those who use them will more effectively control the process and be more consistently followed.

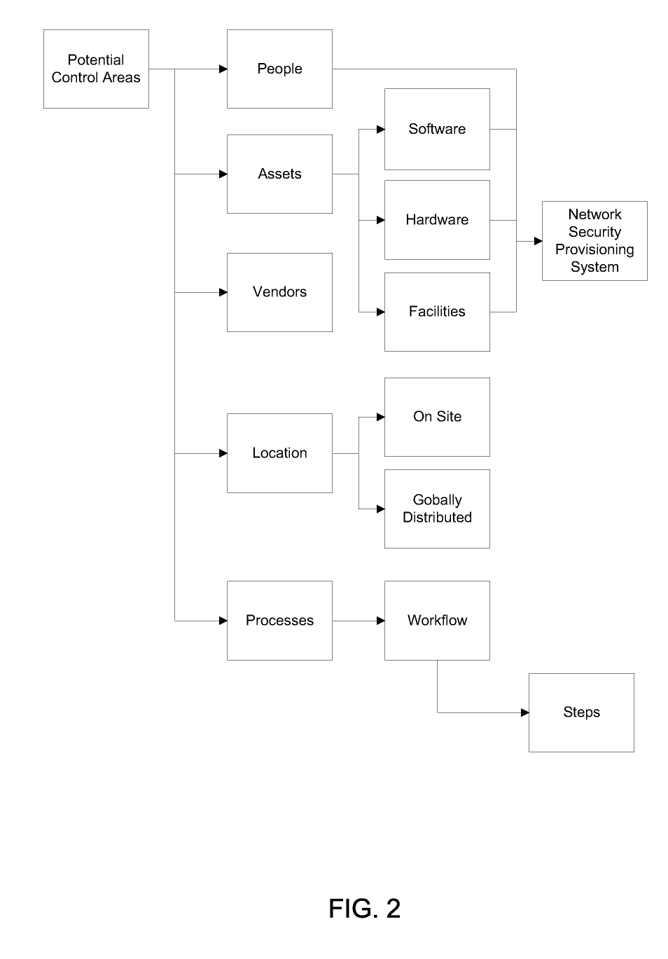

Accordingly, to be successful, the development of a control preferably should be done in the area of the process in which the control will operate. Referring to FIG. 2, an illustration of the various areas in which a control could be located in an information technology process is shown. As an example, a control could be implemented in the software area to ensure that all software purchased is licensed for network distribution prior to being made available on the network via a server. A control intended to reinforce the software control could be implemented in the people area by requiring that the group leader of the information technology department approve all postings of software for network distribution prior to copying of the program to the server. As illustrated in FIG. 2, controls may also be implemented via automated processes, such as a network security provisioning system that operates to monitor compliance by individuals with the existing controls (i.e., the provisioning system notifies the group leader if a member of the group posts software without the group leader first registering an approval of the posting within the provisioning system).

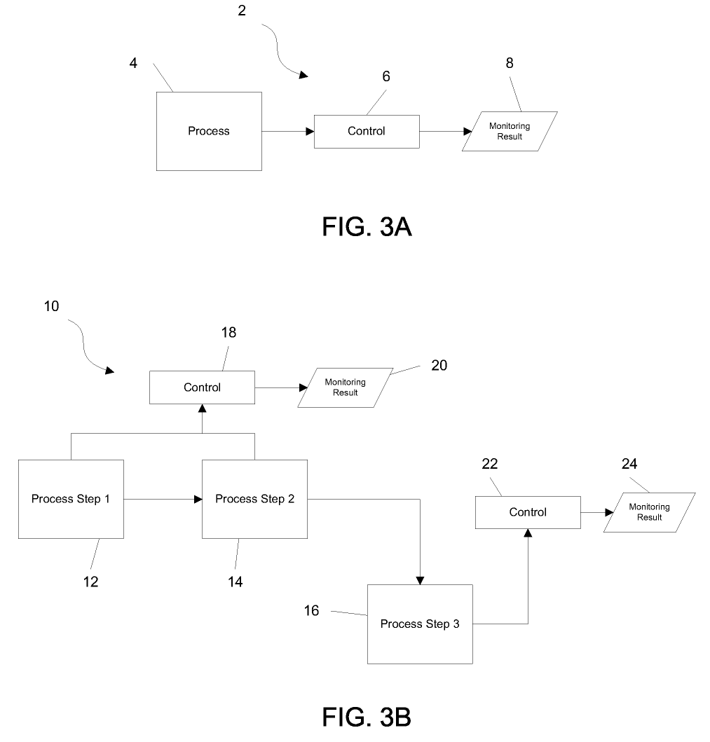

Referring to FIG. 3A, an implementation of a process 2 is illustrated. In FIG. 3A, a process block 4 is coupled with a control 6 that is monitoring the process and producing a monitoring result 8. The control 6 may be any of the various types of controls previously discussed and may perform any of the functions previously discussed. The monitoring result 8 may take a wide variety of forms, including, by non-limiting example, an alarm, data, a paper document, an email, a verbal communication, or any other method or object that can communicate information about a process or process result. The monitoring result 8 may contain information about the process block 4, the control 6, or both, depending upon the control type and the process being monitored. In many audit processes, one of the indicators used to prove that the control 6 is actually operating is the presence of the monitoring result 8, and during an audit, evidence of the monitoring results 8 may be required to prove the control 6's presence as well as measure its overall effectiveness. In particular implementations of a control, the monitoring results 8 may be an audit trail.

Referring to FIG. 3B, an implementation of a process 10 is illustrated that includes process steps 12, 14, and 16. As illustrated, control 18 monitors process steps 12 and 14 and produces monitoring result 20 while control 22 monitors process step 16 and produces monitoring result 24. The process 10 illustrates how controls can monitor the activity of one or more process steps and produce multiple monitoring results. In particular process implementations, controls may also be monitored by additional controls that serve the additional functions of documenting a control's existence, its operation, or providing a backup in case a particular control fails under a certain set of circumstances. Any of a wide variety of processes, controls, and process/control arrangements can be constructed. FIGS. 3A and 3B illustrate the general relationship of controls, process elements, and monitoring results for the exemplary purposes of this disclosure. In view of these examples, implementations of risk management and compliance systems operate to ensure that the controls in a given process properly promote and assess compliance with various internal and external process requirements while serving to reduce risks inherent in the process to desired and/or required levels. As implementations of risk management and compliance systems are discussed in this document, the general relationship of the process and control illustrated in FIGS. 3A and 3B is presented as an aid for understanding of the operation of and relationship of the system implementations relative to the actual process being monitored.

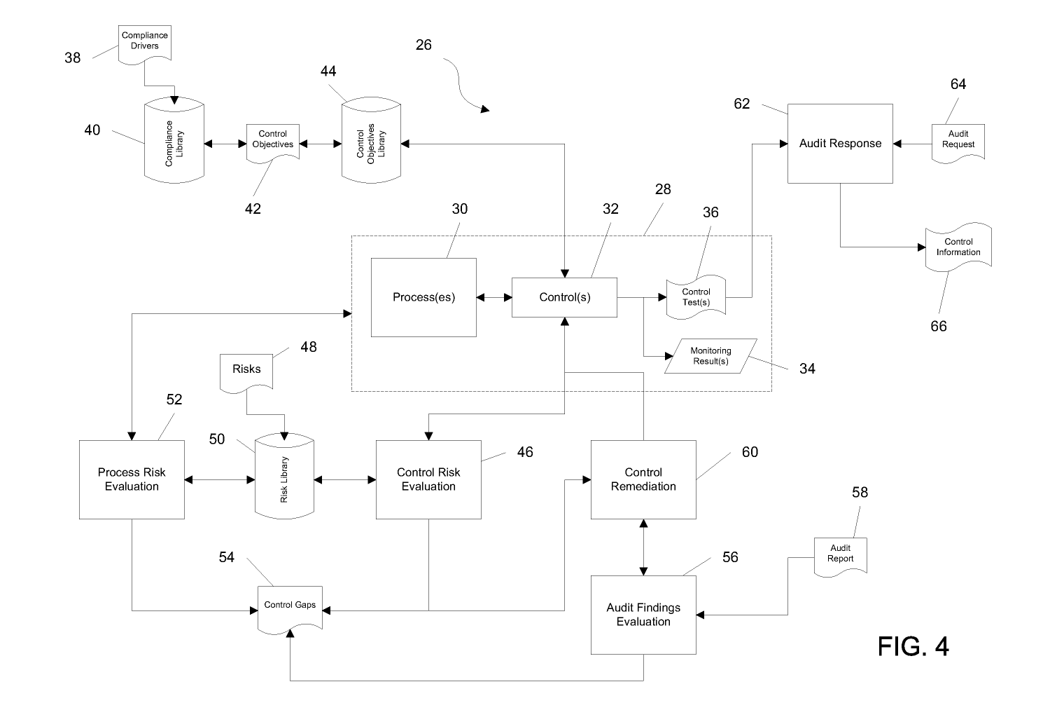

Referring to FIG. 4, a first implementation of a risk management and compliance system 26 is illustrated. As illustrated, the blocks in process 28 illustrate a process similar to the process 2 illustrated in FIG. 3A. Like the process 2 illustrated in FIG. 3A, the process 28 includes a process block 30, a control 32, and a monitoring result 34. The process block 30 can represent a single process step or an entire process or group of processes that may be monitored by control 32. While control 32 appears as a single box, control 32 may represent one or more controls that are monitoring the process block 30. The monitoring result 34 accordingly represents all monitoring results produced by all of the controls represented by control 32, including audit trails. Control test 36 represents one or more control tests that may be used to monitor the performance of or certify the one or more controls represented by control 32. A control test 36 includes the procedures needed to test the operation of a particular control to determine whether it is robust to potential failure modes, properly operates, and produces the desired monitoring result 34. Control test 36 may permit the control 32 to be certified and through execution of control test 36, particular output may be obtained that may be used to prove to outside auditors that, by non-limiting example, the control 1) has been validated, 2) that it performs as asserted, and 3) the date and/or time of the test.

As illustrated in FIG. 4, a large number of other components of the risk management and compliance system implementation 26 exist outside the process 28. However, FIG. 4 illustrates how the risk management and compliance system 26 is designed to interact with the process 28 and the control 32 to ensure that the process 28 and control 32 are properly designed and certified to mitigate risks in the process 28 and risks in the control 32 and to conform with internal and external standards.

Compliance with internal and external standards begins with the aggregation of various internal and external standards as compliance drivers 38. Any of a wide variety of standards can be a compliance driver 38, such as, by non-limiting example, legal standards embodied in various processes, such as Sarbanes-Oxley process, the Federal Depository Insurance Corporation process; process and business improvement processes promulgated by private groups such as the Six Sigma Reengineering process; internal compliance processes; internal policies; management directives; customer requirements; department objectives; and any other standard internal to or external to the process. The compliance drivers 38 are assembled and stored in compliance library 40. The compliance drivers 38 in the compliance library 40 are then used to form one or more control objectives 42. The one or more control objectives 42 describe what the controls in the process are intended to do to implement what the compliance drivers 38 require. The one or more control objectives 42 are stored in a control objectives library 44. The compliance library 40 and the control objectives library 42 may take any of a wide variety of forms, such as, by non-limiting example, computer readable data on computer readable media in a single database, computer readable data on computer readable media in a plurality of databases, paper documents or tables, or any other form of data or information storage.

With the one or more control objectives 42 in the control objective library 44, one or more controls represented by control 32 can be developed. As steps in the development process, the control objectives 42 may be used to determine what area in the process block 30 to assign development of the control 32. Individuals and/or entities working in that area of the process block 30 then are tasked with the responsibility to develop a control 32 that fulfils the assigned process objective(s) 42. Once the control 32 has been developed, the individuals and/or entities are then responsible to develop the control test 36 that will be used to determine whether the control 32 operates as designed and which may be used to certify the control 32. If the control 32 does not pass the control test 36, it may be redesigned and/or recertified as required. Once the control 32 has passed the control test 36, it is ready for additional risk management and compliance evaluation.

A control risk evaluation module 46 is coupled with the control 32 and may be configured to perform various risk assessment processes with the control 32 to determine the inherent risk in the process the control 32 is intended to mitigate, the level of acceptable risk, the mitigated risk, and the level of residual risk remaining after the implementation of the control 32. Examples of risk assessment processes that may be used include, by non-limiting example, focused group discussions, failure mode effects analysis, fishbone diagrams, component-by-component analyses, process or control expert analysis, and any other method of risk analysis. The risk assessment process utilizes one or more risks 48 or risk criteria (which may be predetermined) that are stored in a risk library 50. The risks 48 may be, by non-limiting example, legal and regulatory requirement risks, internal and/or external policy risks, standards risks, aggregated risks, objective risks, control area member risks, or any other standard, situation, or outcome that has the potential for negative or positive impact on the process. The control risk evaluation module 46 functions to evaluate the risks associated with the control 32, which may include, by non-limiting example, the ability of the control to mitigate process risk and/or risks associated with the ability of the control 32 to be complied with, and the ability of the control 32 to produce output that is compliant with the control objectives 42, and any other risk mitigation or compliance issue.

A process risk evaluation module 52 is also coupled with the process 28 and may be configured to perform various risk assessment processes with the process 28. The risk assessment processes utilized may be the same as those utilized by the control risk evaluation module 46 but may also include techniques that are focused on identifying and resolving integrated risk and compliance-related issues. The process risk evaluation module 52 utilizes the one or more risks 48 stored in the risk library 50. The risks 48 may be the same as those used by the control risk evaluation module 46 or may be other risks 48 that focus on process-specific risks, such as, by non-limiting example, risks associated with integrated process steps governed by separate controls, risks associated with simultaneous or successive failures of particular controls or process steps, or risks and/or compliance issues resulting from layered implementations of controls monitored by other controls. While serving to assess overall process risks, the process risk evaluation module 52 may also function to evaluate how well process risks are being mitigated by the control 32 overall, since one of the primary purposes of the control 32 is to mitigate particular risks already identified in the process. Because the control 32 can represent more than one control, the process risk evaluation module 52 may go beyond a mere assessment of each control in turn and permit a review of the overall effectiveness of all of the controls in the process 28 simultaneously.

As the control risk evaluation module 46 and process risk evaluation module 52 operate, one or more control gaps 54 are generated by each. Each of the control gaps 54 may be, by non-limiting example, a change to the control 32 that will allow for further mitigation of one or more of the risks 48, a change to the control 32 that will allow for more efficient operation of the overall process 28, a change to the control 32 that will produce an improved monitoring result 34, a change to the control 32 that will permit the control 32 to pass the control test 36 and/or be certified by the control test 36, a change to the control 32 that will enable the control 32 or the process 28 to more fully comply with one of the control objectives 42 and/or the compliance drivers 38, or any other change to the control 32, change to the process block 30, or change to the process 28. The control gaps 54 can also be generated by an audit findings evaluation module 56 coupled with the control 32 and configured to receive an audit report 58 that may be from either internal or external auditing activity and that may contain one or more or audit findings indicating what the auditor sees as risks and/or gaps in the process 28, control 32, monitoring results 34, or the control test 36. The audit report 58 may be formally generated, such as during an external audit, or less formally created through an internal audit or other self-assessment process. The audit findings evaluation module 56 may be configured to evaluate the one or more audit findings in the audit report 58 and determine what control gaps 54 will best address relevant audit findings.

The control gaps 54 are utilized by and can also be generated by a control remediation module 60 that is coupled with the control 32. The control remediation module 60 may be configured to receive the control gaps 54 produced by the other modules and perform whatever functions are required to implement and/or make the changes with the control 32, such as, by non-limiting example, assigning the changes to an appropriate area or individual, engaging management to aid in determining priorities, authorizing the purchase of new equipment, scheduling and developing employee training, or any other task, process, item, thing, or individual that is needed to change the control 32. While the control remediation module 60 is operating, additional control gaps 54 may be identified that cannot be resolved by closing the already-identified gap in the control 32. These additional control gaps 54 may be taken up in their turn or sent to any of the other modules for further evaluation.

While the modules just described focus primarily on the activities of the control 32 and the process 28, implementations of risk management and compliance systems 26 may include components that help communicate existing information to auditors to demonstrate compliance with defined systems and that aid in assuring that identified risks are actually being mitigated. An audit response module 62 may be configured to receive an audit request 64 from an internal or external individual or entity and produce control information 66 that relates to the control 32, the control test 36, the process block 30, or the monitoring result 34. The control information 66 may permit the auditing entity or individual to determine whether the control 32 is, by non-limiting example, functioning as designed, being actually used, being complied with, producing meaningful results, properly mitigating the risks for which it is intended, or indicating that the process 28 is producing product meeting specifications, or any other auditable parameter relating to the process 28 or control 32. The audit response module 62 may produce what may be used to demonstrate real-time or near real-time compliance with existing systems, reducing the likelihood that an auditor will feel the need or be allowed to pursue a further “fishing expedition” into a process or control's details during an audit.

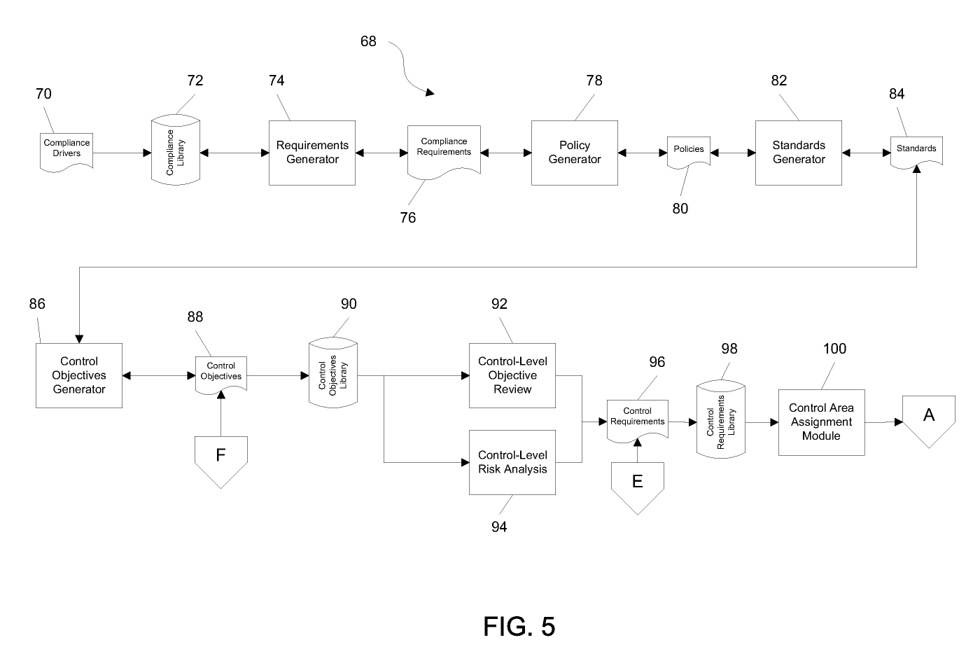

Referring to FIGS. 5, 6, 7, and 8, first, second, third, and fourth sections of a second implementation of a risk management and compliance system 68 are illustrated. While the risk management and compliance system 68 is divided across four figures for ease of illustration, it must be understood that the actual system implementations are not physically divided into sections as illustrated on the figures. Referring to FIG. 5, the risk management and compliance system 68 includes a plurality of compliance drivers 70 that may be any one or more of the drivers discussed previously in this document. The compliance drivers 70 are stored in a compliance library 72, which may be any data storage device or method previously discussed in this document. A requirements generator 74 is coupled with the compliance library 72 and receives the plurality of compliance drivers 70 and uses them to generate compliance requirements 76. The compliance requirements 76 may be, by non-limiting example, the actual list of things that must be done, documents produced, or specifications to be met that will satisfy the compliance drivers 70. The requirements generator 74 may utilize a wide variety of techniques to determine what the compliance requirements 76 may be, including, by non-limiting example, legal research, customer meetings, proof-of-concept testing, or any other method of determining or validating a standard or requirement.

Once the compliance requirements 76 have been generated, a policy generator 78 may take the compliance requirements 76 and determine what company or process policies 80 may be required to implement the compliance requirements 76. At times, a policy 80 cannot be immediately generated, and may require additional work by management or other personnel and may involve other entities, such as regulatory agencies, to determine what policy 80 will be able to implement a particular or group of compliance requirements 76. Once the policies 80 have been generated, a standards generator 82 determines the company or process standards 84 that will be required to enact one or a group of the policies 80. Each stage of the process of moving from driver to requirement to policy to standards may further increase the level of detail of the tasks to be performed, documents to be created, or the process specifications to be met at various process steps in the process. With this more detailed information, for example, users of implementations of a risk management and compliance system 68 may be able to move from the problem statement of, for example, “Implement Sarbanes-Oxley” to stating that one of the requirements is that a particular set of documents that must be signed by the CEO to comply with one of the Sarbanes-Oxley reporting requirements.

Once the standards 84 have been developed, a control objectives generator 86 takes the various standards 84 and uses them to generate one or more control objectives 88. The control objectives 88 define what a control or group of controls needs to be developed to meet a particular one of or group of the standards 84. The control objectives 88 may then be stored in a control objectives library 90, which may also take the form of any of the other libraries discussed in this document. Because all of the control objectives 88 are stored in the same control objectives library 90, all of the objectives may be simultaneously accessible to all employees and management at the company, preventing duplication and promoting cross-departmental and cross-process communication. In addition, a uniform set of criteria governing what a control objective should include can be imposed on all control objectives for all controls in the process.

Once the control objectives 88 have been defined and stored in the control objectives library 90, the control objectives 88 are used by a control-level objective review module 92 and a control-level risk analysis module 94. The control-level objective review module 92 may examine one or more of the control objectives 88 and determine what control requirements 96 are needed to meet the control objective 88. The control-level risk analysis module 94 may examine the risks associated with one or more of the control objectives 88 and fashion control requirements 96 that are needed to mitigate the risks identified. The control requirements 96 are then stored in a control requirements library 98, which may be configured like any of the other libraries discussed in this document. With the control requirements 96 defined, the area of the process where development of the actual control or controls that will implement the requirements will take place must be determined. A control area assignment module 100 retrieves the control requirements 96 from the control requirements library 98 and determines what area in the process or individual or group of individuals should be assigned to develop the needed control or controls. Experience has shown that controls developed in the appropriate process area and/or by the individuals working in that area are more likely to be complied with, to function as desired, and to be used.

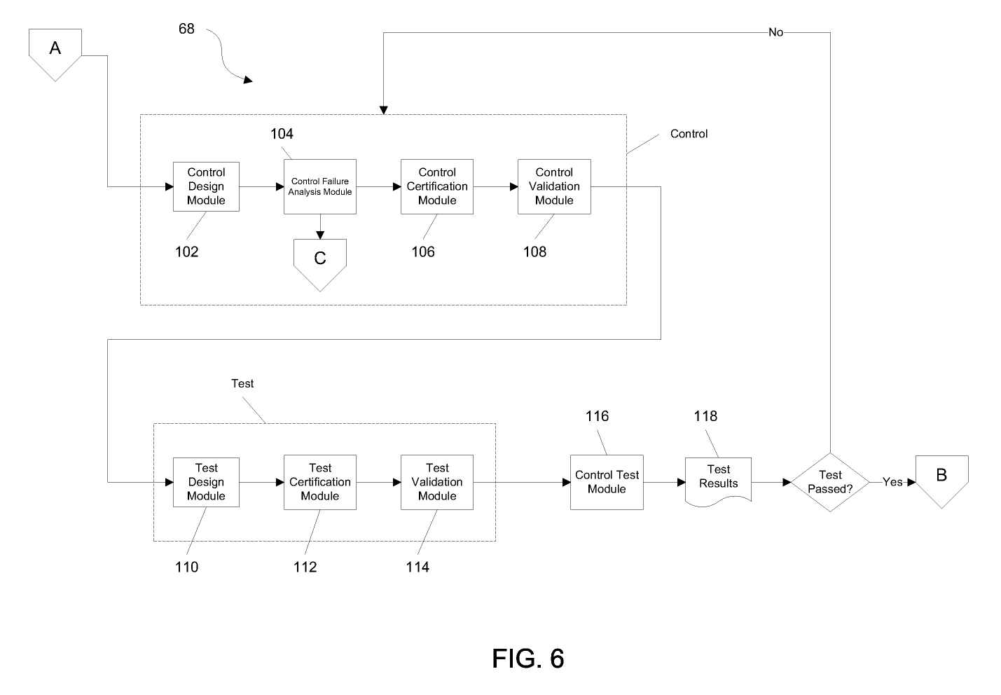

Referring to FIG. 6, at reference A once the development of a control has been assigned to a particular area, the work of designing, testing, and validating the control design begins. In the box labeled Control, four modules are included that are used to facilitate this process. The first is the control design module 102, which may be configured to receive one or more of the assigned control requirements 96 and determine, by non-limiting example, the basic operation, features, inputs and outputs, or any other characteristic of the control. The work of the control design module 102 may include, by non-limiting example, various meetings between individuals tasked with control design, work by process experts, experiments, proof-of-concept validations, and any other activity that will facilitate the determination of and evaluation of control structures and procedures. Following or in conjunction with the activities taking place in the control design module 102, a control failure analysis module 104 may be utilized to perform various failure analysis and/or risk assessment processes on the structures and/or procedures being developed or which have been developed as part of a control. Part of the work of the control failure analysis module 104 is to identify aspects of the control that will not be sufficient to mitigate certain risks or to meet certain elements of the control requirements 96 and pass that information along to further process modules to determine what should be done if the control design fails (as indicated by reference C).

After the control design module 102 and control failure analysis module 104 have completed their work, the resulting control design is received by a control certification module 106. The control certification module 106 performs a first check on the control design to ensure that it will operate efficiently in the process location or other environment where it will be implemented and that the control meets basic internal and external audit requirements (such as producing documentation of its operation, etc.). After the control certification module 106 has ensured that the control design meets these requirements, a control validation module 108 performs two additional validating procedures on the control design. The first validation procedure audits the performance of the control within its environment by conducting a test of details to see if the control actually performs as designed. The second validation procedure audits individuals responsible for performing or utilizing the control by conducting a test of execution to see if the control is being used as designed. When the control design passes these two validation procedures, it is ready for further testing.

The box labeled Test includes three modules that are intended to generate a control test design that will adequately assess the performance of the certified and validated control design. The first of these is a test design module 110, which may be configured to receive the control design and determine the structures and/or procedures of the control test that will be sufficient to verify the operation of the control. In particular implementations of risk management and compliance systems 68, the procedures followed during control certification and validation by the control certification module 106 and the control validation module 108 may be analogized to “happy path” testing in software development, where the software and related systems are first tested to see if they will do what they are supposed to when all operational steps are followed. A control test, however, may be analogized to a real world testing situation, where “non-happy path” scenarios that include errors and missed or out-of-order steps are introduced while the control design is operating. Until the control design is tested using real world situations, a control design's actual degree of risk mitigation and its ability to survive a real audit may not be capable of full determination. Accordingly, a proper control test design may be key to adequately assessing a control design's strengths and weaknesses.

After a test design has been developed using the test design module 110, the design is passed to a test certification module 112 and test validation module 114 that each may operate similarly to the control certification module 106 and test validation module 108 by certifying that the test design will produce auditable results and function as designed and validate the function of the test.

Once the control design and test design have been validated, they are passed to a control test module 116 where a test of the control design is executed using the test design. A wide variety of methods of executing the test design may be employed by the control test module 116, including, by non-limiting example, statistical testing, random sampling, testing on a frequency related to the frequency of execution of the control, or any other testing method. After the execution of one or more tests using the control design and the test design, one or more test results 118 are produced. Based upon the test results 118, an individual, entity, or process may determine that the results are sufficient to indicate that the control will meet the control requirements and mitigate the risks it is intended to mitigate and/or produce the documentation or other evidence of compliance that can be used for auditing purposes. If the control design passes the test requirements, the control design is implemented in the process (following indicator B). If the control design does not pass after testing, then the design is referred to any one or all of the modules in the box labeled Control for redesign, additional failure analysis, recertification, and/or revalidation.

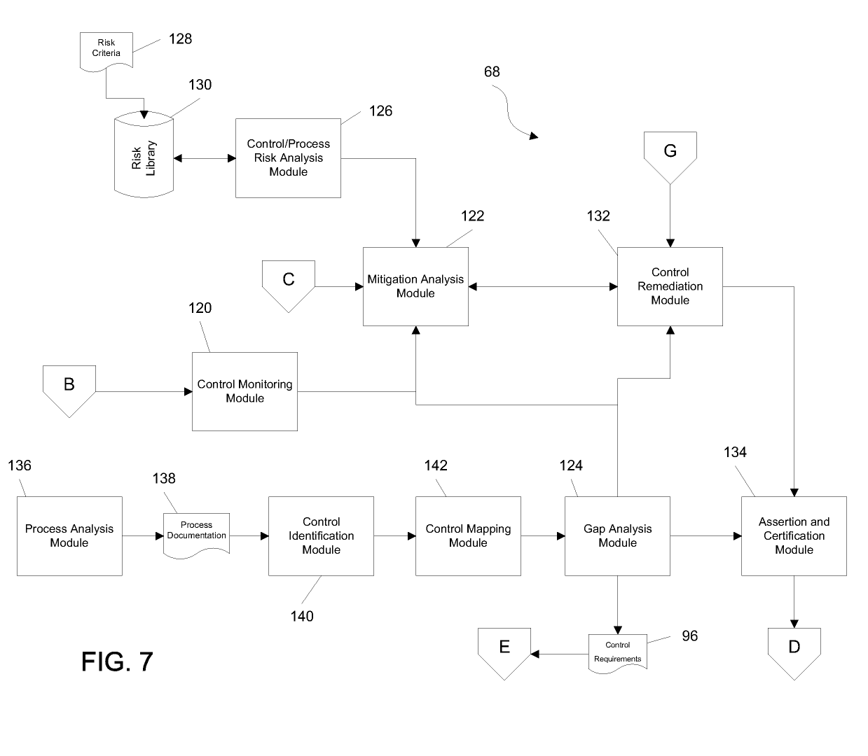

Referring to FIG. 7, at indicator B, a control monitoring module 120 is included to monitor the implemented control and transmit monitoring results to a mitigation analysis module 122 included in the system. The control monitoring module 120 watches the controls and the risks associated with the controls and the process on an ongoing basis and signals the mitigation analysis module 122 if any problems with the control or controls being monitored in the process or any risks are detected. The mitigation analysis module 122 also receives information from the control failure analysis module 104 as indicated by indicator C that discloses risks or required documentation that are not or may not be mitigated by the particular control design under certain or all failure conditions. The mitigation analysis module 122 receives this information and determines what steps, processes, structures, or plans should be put in place when the control fails under these conditions and generates control gaps that are passed on to a gap analysis module 124 for further evaluation.

The mitigation analysis module 122 also receives information about the risks in one or more controls in the overall process from a control/process risk analysis module 126, which may be configured to analyze one or more controls and one or more processes containing one or more controls external form the previously described control development process using risks 128 stored in a risk library 130. The control/process risk analysis module 126 may function as two separate modules, one evaluating each control in the process, and the other evaluating each process, process step, or group of processes for process-specific and/or integrated effects that may create risks or compliance issues. In such implementations, the control/process risk assessment module 126 may operate similarly to the control risk evaluation 46 and process risk evaluation 52 modules of the risk management and control system 26 illustrated in FIG. 4.

The mitigation analysis module 122 may also receive information from a control remediation module 132 and from the gap analysis module 124 relating to risks and or compliance issues that need to be evaluated and determine what control gaps will allow mitigation of them. The mitigation analysis module 122 sends generated control gaps to the control remediation module 132 for implementation. The control remediation module 132 may execute some or all of the control design and test design modules illustrated in FIG. 6 as part of remediating one or more controls in the process using the control gaps from the mitigation analysis module 122 and the gap analysis module 124. In addition, the control remediation module 132 may determine the area of the process and/or the individuals who should work to close the control gap.

Once a remediated control design has been produced using the control remediation module 132, it is sent to an assertion and certification module 134. The assertion and certification module 134 may execute some or all of the control design testing modules illustrated in FIG. 6. In addition, the assertion and certification module 134 may evaluate both the remediated control design and initially certified control designs to determine their ability to support an assertion, such as, by non-limiting example, an assertion in a financial statement, the accuracy of a measurement of a key process parameter, the value of a particular transaction, or any other statement or value upon which a customer or other entity would rely. During the operation of the assertion and certification module 134, the test results 118 from the control test module 116 are scrutinized to determine whether exceptions were noted during testing, whether they were resolved, and whether a process exists to correct recurring exceptions.

One of the purposes of the assertion and certification module 134 is to make an assessment of a given control design's ability to reasonably support the assertion noted. The assertion and certification module 134 may be configured to analyze each control in a process as an implementation of a risk management and compliance system 68 is being implemented, and to work on an ongoing basis with remediated or new controls added to the process as the risk management and compliance system 68 is operating. Once the assertion and certification module 134 has completed its work with a control, documentation or other information may be collected or produced relating to the control's ability to mitigate the risk(s) for which has been implemented and/or support the assertion(s) for which it will be used. The information or documentation may be made available during an audit to modules along indicator D.

As illustrated in FIG. 7, additional process evaluation may take place as part of an implementation of a risk management and compliance system 68. A process analysis module 136 may be configured to analyze the process, process step, or group of processes or process steps to document what occurs during the process, which individuals are involved, or any other parameter, structure, or event that takes place when the process or process step is carried out. The process analysis module 136 may produce one or more items of process documentation 138 that document what was determined. With the process documentation 138, a control identification module 140 may be used to determine whether the process documentation 138 indicates whether one or more controls exist in the process and what the controls are.

Once the existing controls in the process are identified, a control mapping module 142 may be used to 1) determine the risks and compliance issues that the existing controls are handling, and 2) evaluate the process using the policies 80 to map existing policies 80 to corresponding implemented controls. The resulting process documentation 138 and control information from the control identification module 140 and the control mapping module 142 are sent to the gap analysis module 124 which may determine what control gaps exist with 1) the existing controls in the process, and 2) what additional control requirements 96 will be needed for the existing controls and for developing new controls to mitigate risks or deal with compliance issues noted. The new control requirements 96 may be forwarded along indicator E for storage in the control requirements library 98.

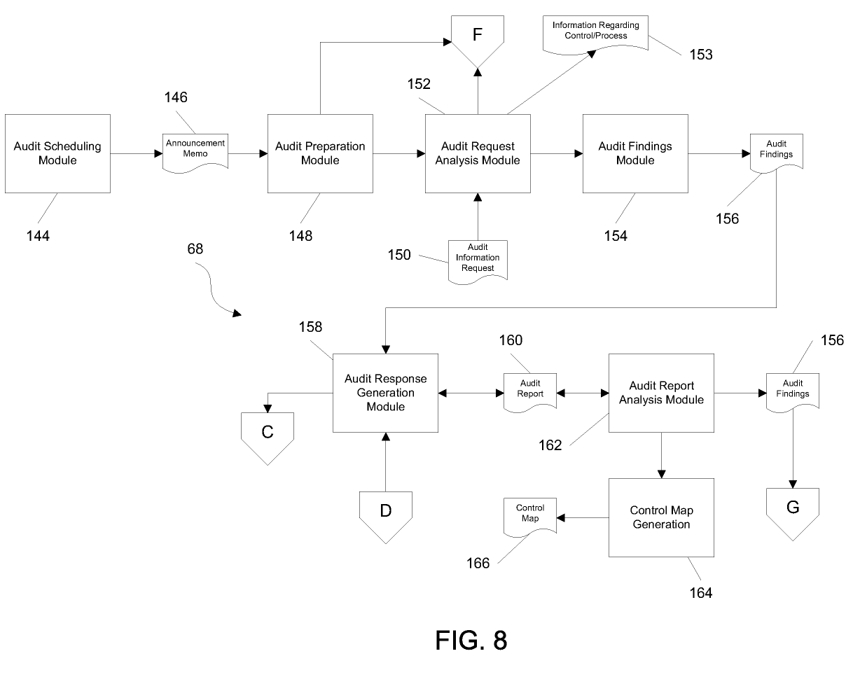

Referring to FIG. 8, portions of an implementation of a risk management and compliance system 68 that interact with and support audit processes are illustrated. As illustrated, an audit scheduling module 144 may be configured to schedule times for the performing of internal audits or to receive requests from outside auditing individuals or entities that an audit be performed. The audit scheduling module 144 generates an announcement memo 146 that serves to notify individuals in the organization and the process that an audit is going to be conducted within a certain time frame. After the announcement memo 146 has been generated, an audit preparation module 148 may be configured to begin evaluating existing controls, processes, and documentation to determine readiness for the audit. As part of its operation, the audit preparation module 148 may generate one or more control objectives 88 that will be passed along indicator F to be stored in the control objectives library 90 for development of additional controls to mitigate risks and/or compliance issues noted during the audit preparation evaluation.

As an audit proceeds, one or more audit information requests 150 may be received by an audit request analysis module 152. The audit request analysis module 152 may take each audit information request 150 and determine what controls in the process or process portions are relevant so that information related to those controls or process portions 153 can be provided to the auditor. During the operation of the audit request analysis module 152, one or more control objectives 88 may be identified in the form of risks or compliance issues not previously noted in existing controls, process portions, or process steps while a response to an audit information request 150 is being developed. These control objectives 88 may be passed along indicator F to be stored in the control objectives library 90.

After analysis of the audit information request 150 has been completed, an audit findings module 154 may analyze the information 153 being provided to the auditor and generate one or more audit findings 156. The audit findings module 154 may be utilized most often when internal audits are being conducted by personnel who are part of the company or part of operating the process. These audit findings 156 may be received by an audit response generation module 158 which may be configured to analyze them and determine which of the audit findings 156 justify further evaluation to see if a response should be made, and if so, the corresponding audit findings 156 are sent to the mitigation analysis module 122 along indicator C. The audit response module 158 may also receive risk mitigation and compliance issues noted during the operation of the assertion and certification module 134 and analyze these issues to see if they should be forwarded to the mitigation analysis module 122 along indicator C, left as residual risk, or noted as known potential process compliance issues.

When internal audits are conducted, the audit response generation module 158 may also produce an audit report 160 that may contain one or more audit findings for distribution within or external to the organization. When external audits are conducted, one or more audit reports 160 may be received and processed by an audit report analysis module 162. The audit report analysis module 162 may operate to assess the audit report 160 and produce one or more audit findings 156 relating to controls in the process that will be forwarded for additional analysis by the control remediation module 132 along indicator G. When internal audits are conducted, however, the audit report analysis module 162 may not be utilized in particular implementations of risk management and compliance systems 68.

The audit report analysis module 162 may also be used to send information relating to the existing controls and process to a control map generating module 164. The control map generating module 164 may operate to produce a wide variety of summaries of the existing controls and/or process documentation including, by non-limiting example, a control map 166, a list of all controls and risks mitigated by the controls, a flowchart showing process steps and corresponding controls, organization charts, or any other document or summary that may be helpful for the audit or documentation purposes.

In implementations of risk management and compliance systems 26 and 68, controls may be developed and monitored through the use of four forms of risk assessment, process risk assessment (PRA), compliance risk assessment (CRA), objective risk assessment (ORA), and risk monitoring risk assessment (RMRA). Each of these types of risk assessment involves a different focus on and analysis of the process and the controls in the process. Process risk assessment is typically carried out by a process owner who reviews the existing process and identifies structures, events, or individuals where the level of risk is unacceptable. Process risk assessment may involve the use of, by non-limiting example, facilitated workshops, process workflow documentation, control identification, control objectives determination, and any other method or process that aids in identifying the structure of and potential failures in a process or control. Compliance risk assessment is often carried out by legal and regulatory personnel in a company who are familiar with the details and requirements of the laws and regulations that impact a process and various controls. Compliance risk assessment may involve the use of, by non-limiting example, surveys, analysis of process elements, analysis of the law and other regulations, and any other method of determining how legal and regulatory requirements may be translated into policies or standards. Objective risk assessment involves an evaluation of the various control objectives in the control objectives library with respect to, by non-limiting example, what the level of risk is for each control objective, what area a control should be implemented in to meet the control objective, control characteristics, and any other process or method for assessing the feasibility and properties of a control. Risk monitoring risk assessment may be used to evaluate the risks inherent in the processes and methods used to evaluate the overall risks in the risk monitoring process itself.

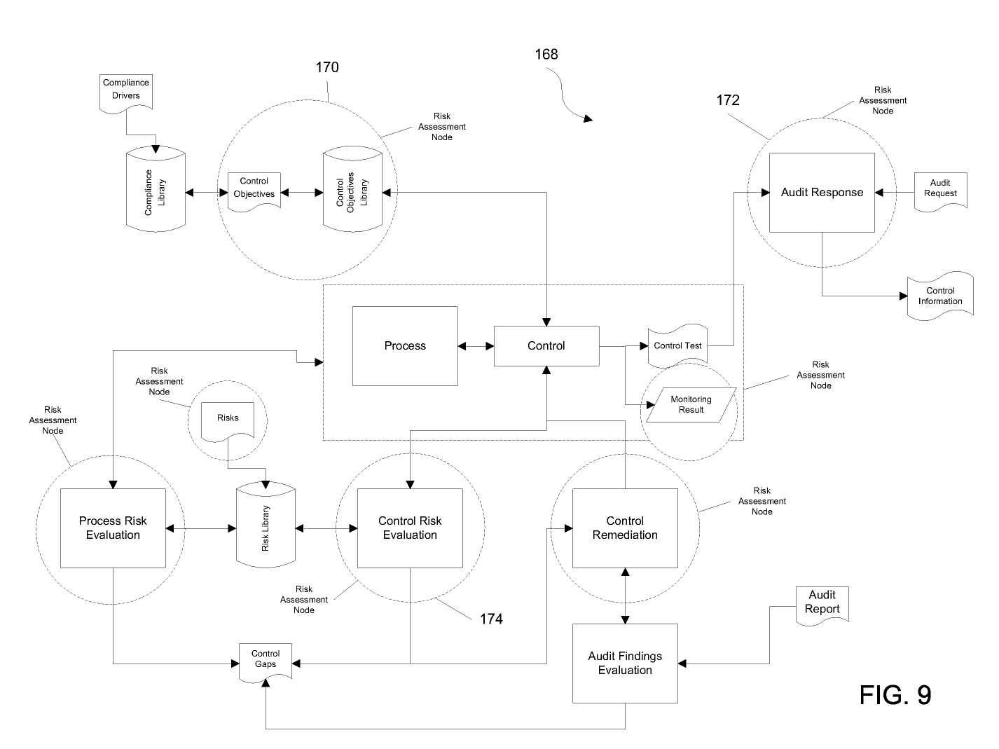

Process risk assessment, compliance risk assessment, objective risk assessment, and risk monitoring risk assessment activities can be carried out at multiple locations and modules within implementations of risk management and compliance systems 26, 68. Implementations of risk management and compliance systems 26, 68 may include a plurality of nodes located at various locations and including various modules within the system implementations. The activities that take place at these nodes may include one or all of the various risk assessment methods discussed above. Referring to FIG. 9, an implementation of a risk assessment and compliance system 168 with a plurality of nodes 170, 172, and 174 is illustrated. In the implementation illustrated in FIG. 9, seven (7) nodes are identified. At each of these nodes, various risk assessment processes could be utilized to evaluate the process and controls within the process. For example, at node 170, objective risk assessment methods could be used to analyze the various control objectives and determine which objectives warrant development of a control. At node 172, process and/or compliance risk assessment methods could be utilized to determine what information relating to a control needed to be provided for an auditor to perform an accurate assessment of the process. At node 174, process and/or compliance risk assessment methods could be employed to adequately assess risks present in a given control or group of controls.

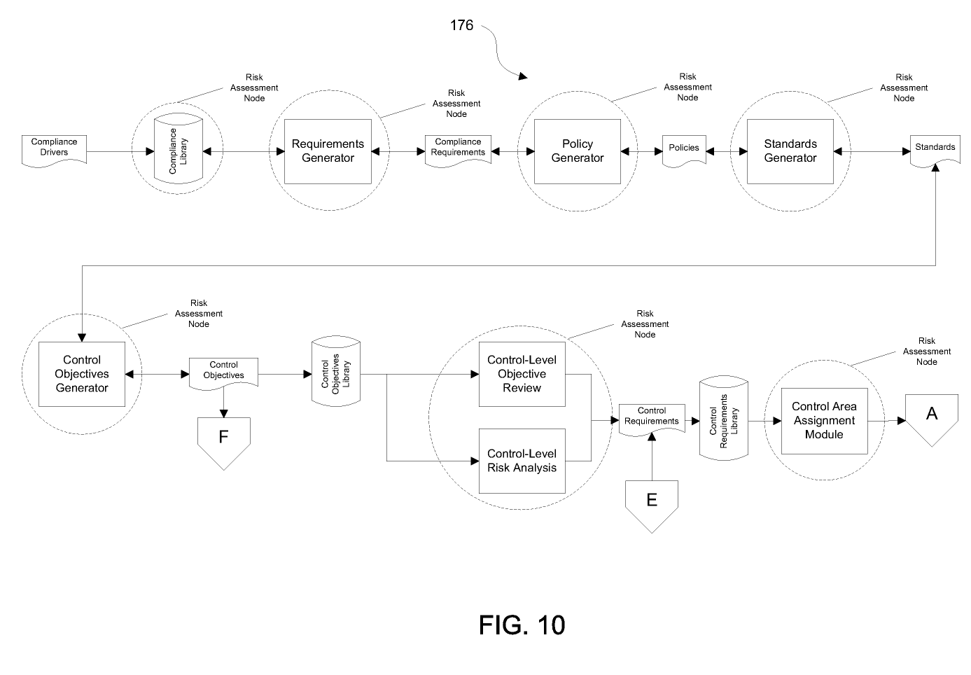

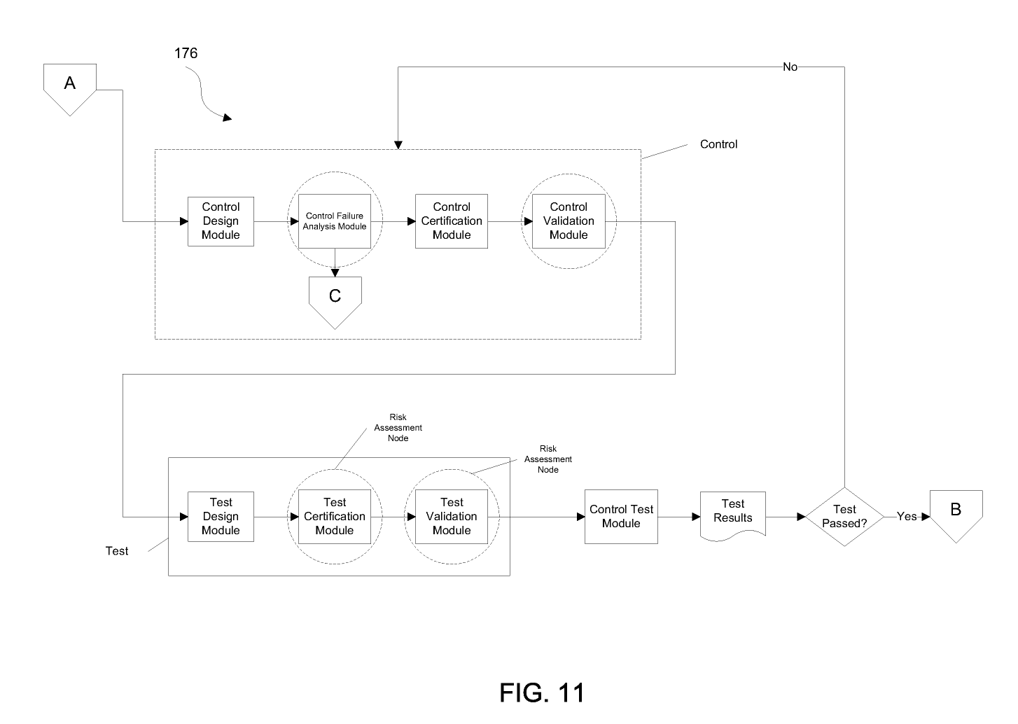

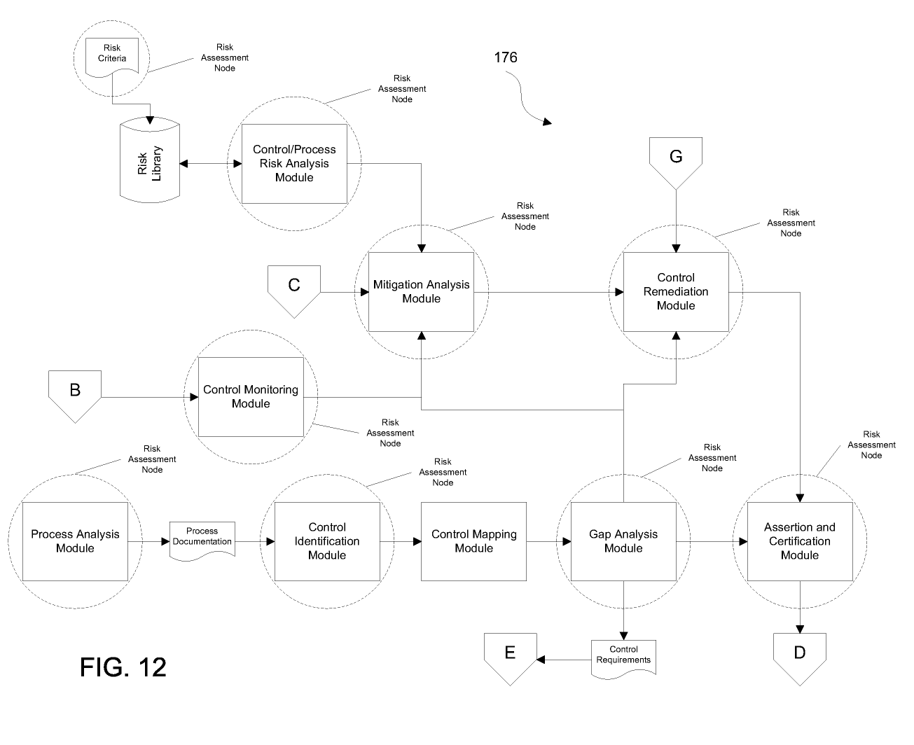

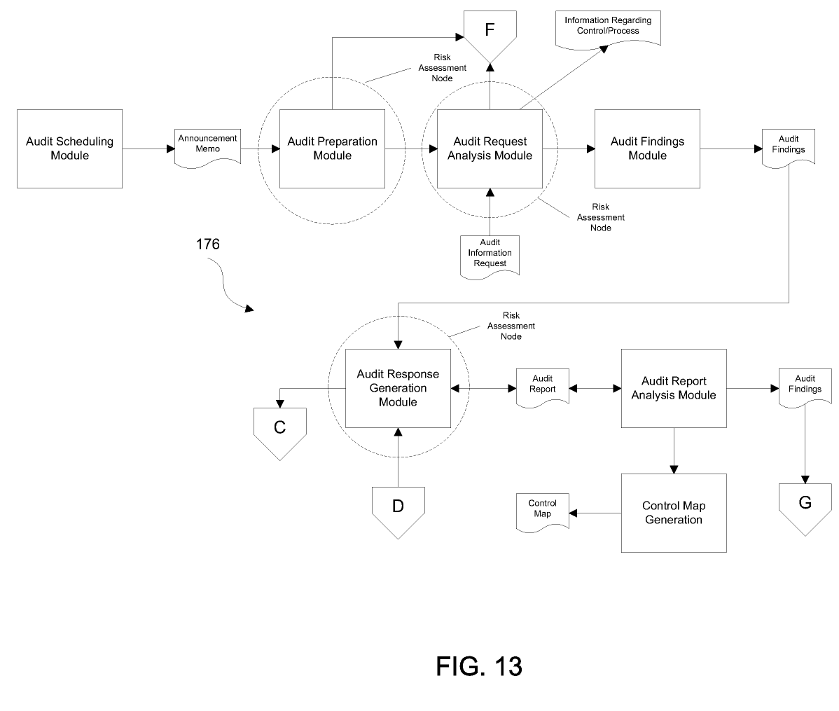

Referring to FIGS. 10, 11, 12, and 13, an implementation of a risk management and compliance system 176 like the implementation illustrated in FIGS. 5, 6, 7, and 8 with a plurality of nodes is illustrated. The number of nodes in the implementations illustrated in FIGS. 10, 11, 12, and 13 is twenty-three (23). Any other number of nodes could be utilized in implementations of risk management and compliance systems 26, 68, 168, and 176. The use of nodes for risk assessment in implementations of risk management and compliance systems 26, 68, and 176 may include the use of various types of nodes that permit the assessment and management of information relating the system itself. Some of these node types may include a control objective mapping node, an audit request analysis node, a providing audit evidence analysis node, and a control remediation control objective mapping node.

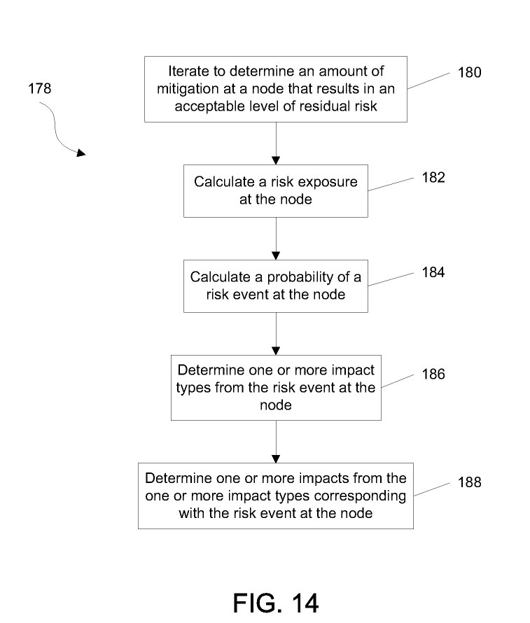

Implementations of risk management and compliance systems employing a plurality of nodes 168 and 176 may also utilize implementations of a method of managing risk at a node. Referring to FIG. 14, an implementation of such a method 178 is illustrated. As illustrated, the method may include iterating to determine an amount of mitigating at a node that results in an acceptable level of residual risk (step 180), calculating a risk exposure at the node (step 182), calculating a probability of a risk event at the node (step 184), determining one or more impact types from the risk event at the node (step 186), and determining one or more impacts from the one or more impact types corresponding with the risk event at the node (step 188). The use of implementations of the method 178 may permit individuals and entities engaged in the various forms of risk assessment discussed in this document to quantify the amount of and the financial and/or business impact of a particular risk at a particular node. Extensive examples of methods for quantifying risk levels and for performing risk analyses at a various nodes may be found in U.S. Provisional Patent Application 60/989,765 entitled “Internal Control and Risk Assessment Systems and Related Methods” to Joseph D. Parales which was previously incorporated herein by reference.

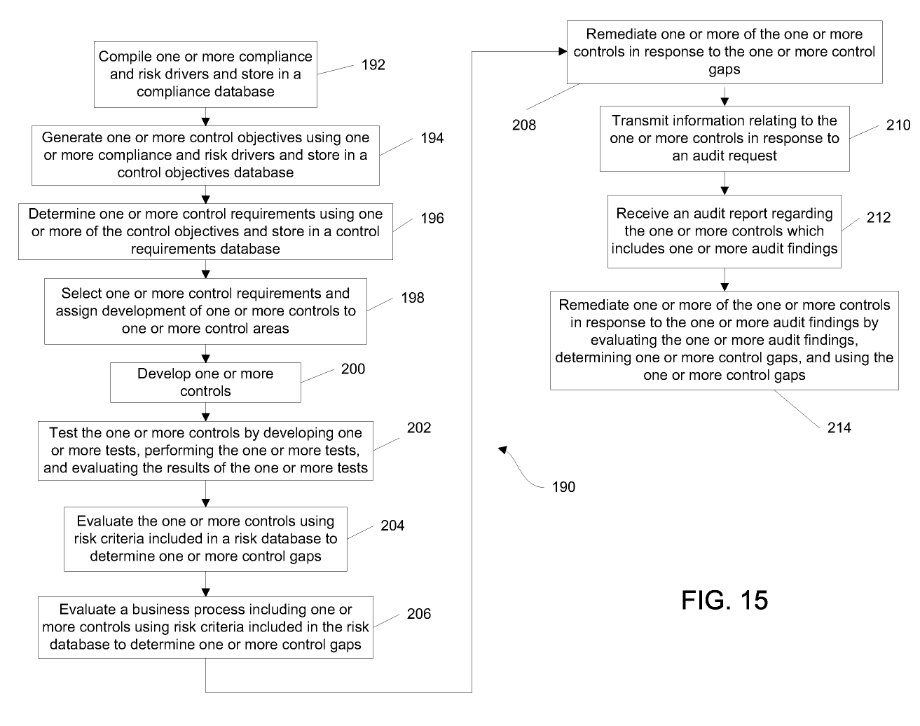

Implementations of risk management and compliance systems 26, 68, 168, and 176 may utilize implementations of a method of implementing a risk management and compliance system 190. Referring to FIG. 15, implementations of the method 190 may include compiling one or more compliance and risk drivers and storing them in a compliance database (step 192), generating one or more control objectives using one or more compliance and risk drivers and storing them in a control objectives database (step 194), and determining one or more control requirements using one or more of the control objectives and storing them in a control requirements database (step 196). Each of the databases described in this document is equivalent to and can include any of the types of and structures of the libraries discussed in this document. The method may also include selecting one or more control requirements and assigning development of one or more controls to one or more control areas (step 198); and developing one or more controls (step 200); testing the one or more controls by developing one or more tests, performing the one or more tests, and evaluating the results of the one or more tests (step 202). The method may also include evaluating the one or more controls using risk criteria included in a risk database to determine one or more control gaps (step 204), evaluating a business process including one or more controls using risk criteria included in the risk database to determine one or more control gaps (step 206), and remediating one or more of the one or more controls in response to the one or more control gaps (step 208). The method may include transmitting information relating to the one or more controls in response to an audit request (step 210); receiving an audit report regarding the one or more controls which includes one or more audit findings (step 212); and remediating one or more of the one or more controls in response to the one or more audit findings by evaluating the one or more audit findings, determining one or more control gaps, and using the one or more control gaps (step 214). Implementations of the method 190 may be utilized when implementing risk management and compliance system implementations in companies or other processes.

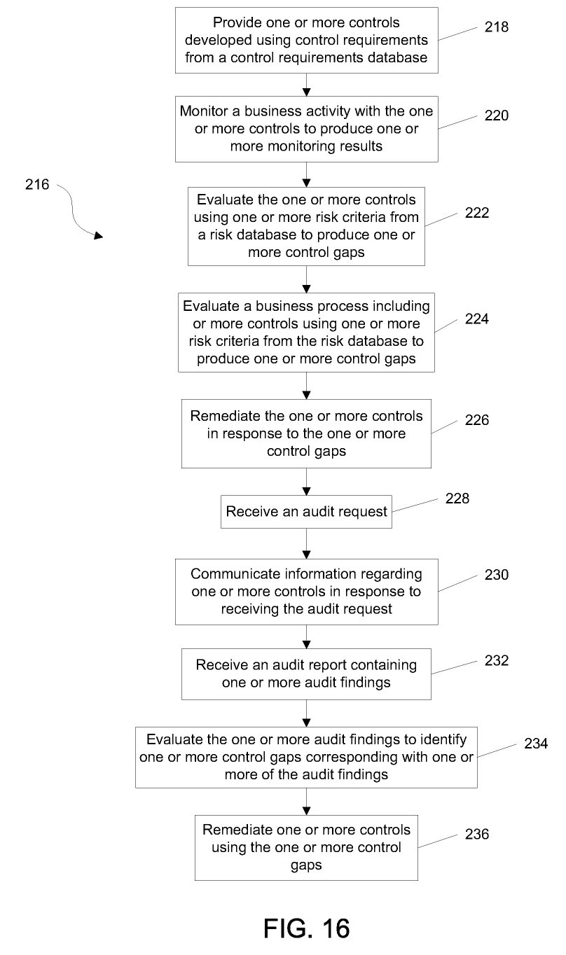

Implementations of risk management and compliance systems 26, 68, 168, and 176 may utilize implementations of a method of managing risk and compliance 216. Referring to FIG. 16, implementations of the method 216 may include providing one or more controls developed using control requirements from a control requirements database (step 218), monitoring a business activity with the one or more controls to produce one or more monitoring results (step 220), and evaluating the one or more controls using one or more risk criteria from a risk database to produce one or more control gaps (step 222). The method may include evaluating a business process including one or more controls using one or more risk criteria from the risk database to produce one or more control gaps (step 224), remediating the one or more controls in response to the one or more control gaps (step 226), and receiving an audit request (step 228). The method may also include communicating information regarding one or more controls in response to receiving the audit request (step 230), receiving an audit report containing one or more audit findings (step 232), evaluating the one or more audit findings to identify one or more control gaps corresponding with one or more of the audit findings (step 234), and remediating one or more controls using the one or more control gaps (step 236). Implementations of the method 216 may be utilized when an implementation of a risk management and compliance system has already been implemented within a company or process. In particular implementations, the audit request may be an external audit request.

In places where the description above refers to particular implementations of risk management and compliance systems it should be readily apparent that a number of modifications may be made without departing from the spirit thereof and that these implementations may be applied to other risk management and compliance systems.

1. A method of implementing a risk management and compliance system, the method comprising:
compiling one or more compliance and risk drivers and storing the one or more compliance and risk drivers in a compliance database;
generating one or more control objectives using the one or more compliance and risk drivers in the compliance database and storing the one or more control objectives in a control objectives database;
determining one or more control requirements using one or more of the control objectives stored in the control objectives database and storing the one or more control requirements in a control requirements database;
selecting one or more control requirements from the control requirements database and assigning development of one or more controls corresponding with the one or more control requirements to one or more control areas;
developing the one or more controls;
testing the one or more controls by developing one or more tests for the one or more controls being developed, performing the one or more tests with the one or more controls, and evaluating the results of the one or more tests;
evaluating the one or more controls using risk criteria included in a risk database to determine one or more control gaps corresponding with the risk criteria;
evaluating a business process comprising one or more controls using risk criteria included in the risk database to determine one or more control gaps corresponding with one or more controls included in the business process or with the business process;
remediating one or more of the one or more controls using the one or more control gaps;
transmitting information relating to the one or more controls in response to an audit request;
receiving an audit report regarding the one or more controls, the audit report including one or more audit findings;
remediating one or more of the one or more controls in response to the one or more audit findings by evaluating the one or more audit findings, determining one or more control gaps corresponding with one or more of the audit findings, and using the one or more control gaps to remediate the one or more controls.

2. The method of claim 1, wherein developing the one or more controls further comprises designing, certifying, and validating the one or more controls.

3. The method of claim 1, wherein developing one or more tests for the one or more controls further comprises designing the one or more tests, selecting a test cycle, certifying the one or more tests, and validating the one or more tests.

4. The method of claim 1, wherein remediating one or more of the one or more controls further comprises redesigning, retesting, or recertifying the one or more controls or adding one or more controls.

5. The method of claim 1, wherein transmitting information relating to the one or more controls in response to the audit request further comprises transmitting an audit trail produced by the one or more controls.

6. The method of claim 1, wherein the one or more compliance and risk drivers include one of the Sarbanes-Oxley process, the Federal Depository Insurance Corporation process, the Six Sigma Reengineering process, internal compliance processes, internal policies, management directives, customer requirements, department objectives, and any combination thereof.

7. The method of claim 1, wherein evaluating the one or more controls and evaluating a business process comprising one or more controls further includes evaluating risk at one or more of a plurality of nodes included in a risk management and compliance system using risk criteria included in a risk database.

8. The method of claim 7, wherein evaluating risk at one or more of the plurality of nodes included in the risk management and compliance system may further comprise performing one of Process Risk Assessment (PRA), Compliance Risk Assessment (CRA), Objective Risk Assessment (ORA), Risk Monitoring Risk Assessment (RMRA), and any combination thereof.

9. The method of claim 7, wherein evaluating risk at one or more of the plurality of nodes included in the risk management and compliance system further includes identifying objectives for assessing and managing information relating to the risk management and compliance system at a control objective mapping node, an audit request analysis node, a providing audit evidence analysis node, and a control remediation control objective mapping node.

10. The method of claim 7, wherein evaluating risk at one or more of the plurality of nodes included in the risk management and compliance system further includes using a method of managing risk at a node, the method comprising:
iterating to determine an amount of mitigation at the node that results in an acceptable level of residual risk;
calculating a risk exposure at the node;
calculating a probability of a risk event at the node;
determining one or more impact types from the risk event at the node; and
determining one or more impacts from the one or more impact types corresponding with the risk event at the node.

11. A method of managing risk and compliance comprising:
providing one or more controls developed using one or more control requirements from a control requirements database, the one or more control requirements based on one or more control compliance and risk drivers from a compliance database, the one or more controls validated using one or more tests;
monitoring a business activity with the one or more controls to produce one or more monitoring results;
evaluating the one or more controls using one or more risk criteria from a risk database to produce one or more control gaps;
evaluating a business process comprising one or more controls using one or more risk criteria from the risk database to produce one or more control gaps;
remediating one or more of the one or more controls in response to the one or more control gaps;
receiving an audit request;
communicating information regarding the one or more controls in response to receiving the audit request;
receiving an audit report, the audit report comprising one or more audit findings;
evaluating the one or more audit findings to identify one or more control gaps corresponding with the one or more of the audit findings; and
remediating one or more of the one or more controls using the one or more control gaps corresponding with the one or more audit findings.

12. The method of claim 11, wherein remediating one or more of the one or more controls further comprises redesigning, retesting, and recertifying the one or more controls or adding one or more controls.

13. The method of claim 11, wherein communicating information relating to the one or more controls in response to the audit request further comprises transmitting an audit trail produced by the one or more controls.

14. The method of claim 11, wherein evaluating the one or more controls and evaluating a business process comprising one or more controls further includes evaluating risk at one or more of a plurality of nodes included in a risk management and compliance system using risk criteria included in a risk database.

15. The method of claim 14, wherein evaluating risk at one or more of the plurality of nodes included in the risk management and compliance system includes performing one of Process Risk Assessment (PRA), Compliance Risk Assessment (CRA), Objective Risk Assessment (ORA), Risk Monitoring Risk Assessment (RMRA), and any combination thereof.

16. The method of claim 14, wherein evaluating risk at one or more of the plurality of nodes included in the risk management and compliance system further includes identifying objectives for assessing and managing information relating to the risk management and compliance system at a control objective mapping node, an audit request analysis node, a providing audit evidence analysis node, and a control remediation control objective mapping node.

17. The method of claim 14, wherein evaluating risk at one or more of the plurality of nodes included in the risk management and compliance system further includes using a method of managing risk at a node, the method comprising:
iterating to determine an amount of mitigation at the node that results in an acceptable level of residual risk;
calculating a risk exposure at the node;
calculating a probability of a risk event at the node;
determining one or more impact types from the risk event at the node; and
determining one or more impacts from the one or more impact types corresponding with the risk event at the node.

18. A risk management and compliance system comprising:
a compliance database configured to receive one or more compliance and risk drivers;
a control objective database coupled with the compliance database, the control objective database configured to receive one or more control objectives, the control objectives based at least in part on the one or more compliance and risk drivers;
one or more controls configured to correspond with the one or more control objectives stored in the control objective database and configured to monitor a business activity to produce one or more monitoring results;
one or more tests coupled with the one or more controls configured to validate the performance of the one or more controls;
a control risk evaluation module coupled with the one or more controls and coupled with a risk database, the control risk evaluation module configured to evaluate the one or more controls using one or more risk criteria stored in the risk database and to produce one or more control gaps;
a process risk evaluation module coupled with the risk database and configured to evaluate a process comprising one or more controls using the one or more risk criteria stored in the risk database to produce one or more control gaps;
a control remediation module coupled with the one or more controls and to an audit report findings evaluation module, the control remediation module configured to remediate one or more controls using the one or more control gaps;
an audit response module coupled with the one or more controls and configured to receive one or more audit requests and to communicate information relating to the one or more controls in response to the one or more audit requests; and
an audit findings evaluation module coupled with the one or more controls, the audit findings evaluation module configured to receive one or more audit reports including one or more audit findings, to evaluate the one or more audit findings, and to generate one or more control gaps corresponding with one or more of the audit findings.

19. The system of claim 11, further comprising a plurality of nodes and the control risk evaluation module and the process risk evaluation module configured to evaluate the one or more controls and to evaluate the process comprising one or more controls at one or more of the plurality of nodes included in the risk management and compliance system.

20. The system of claim 19, wherein the control risk evaluation module and the process risk evaluation module are configured to evaluate risk at a node by:
iterating to determine an amount of mitigation at the node to obtain an acceptable level of risk;
calculating a risk exposure at the node;
calculating a probability of a risk event at the node;
determining a type of impact from the risk event at the node; and
determining a financial impact of the risk event at the node.
